(19) United States
(12) Patent Application Publication
(10) Pub. No.: US 2022/0318651 A1
(43) Pub. Date: Oct. 6, 2022

(54) SAFE OVERRIDE OF AI-BASED DECISIONS

(71) Applicant: Accenture Global Solutions Limited, Dublin (IE)

(72) Inventors: Christophe Dominique Marie Gueret, Dublin (IE); Luca Costabello, Newbridge (IE)

(21) Appl. No.: 17/218,308

(22) Filed: Mar. 31, 2021

(51) Int. Cl. G06N 5/04; G06N 20/20

(52) U.S. Cl. CPC G06N 5/04; G06N 20/20

(57) ABSTRACT

Implementations for selectively enabling override of an inference result provided by an artificial intelligence (AI) system can include receiving an input case, outputting a first inference result by processing the input case through a machine learning (ML) model, and determining that a confidence score associated with the first inference result fails to meet a threshold, and in response: providing an adapted ML model based on a set of additional cases, outputting a second inference result by processing a current case through the adapted ML model, the current case including the input case, and selectively transmitting instructions to display an override element with the first inference result in a user interface.

### BACKGROUND

Technologies related to artificial intelligence (AI) and machine learning (ML), AI and ML being used interchangeably herein, have been widely applied in various fields. For example, AI-based decision systems can be used to make decisions on subsequent tasks. In one example context, an AI-based decision system can be used to make a decision on a treatment course of a patient (e.g., prescribe/not prescribe a drug). In another example context, an AI-based decision system can be used to make a decision on whether to approve a customer for a loan. In general, an output of an AI-based decision system can be referred to as a prediction or an inference result.

However, the ML models that underly AI-based decision systems are black-box to users. For example, data is input to a ML model, and the ML model provides output based on the data. The ML model, however, does not provide an indication as to what resulted in the output (i.e., why the ML model provided the particular inference result). In view of this, so-called explainable AI (XAI) has been developed to make the black-box of AI more transparent and understandable. In general, XAI refers to methods and techniques in the application of AI to enable results being more understandable to users and can include providing reasoning for inference results and presenting inference results in an understandable way.

Even with XAI, when it comes to critical issues (e.g., medical diagnosis, investment decisions), users may not want to adopt predictions made by ML models. For example, a user may recognize that an inference result is not optimal or is even incorrect for a given scenario. Here, the user may want to be able to opt-out of accepting the inference result and/or override the inference result with a user-determined result. However, traditional AI-based decision systems are absent technologies to enable such user action in a safe manner.

### SUMMARY

Implementations of the present disclosure are generally directed to selectively enabling override of an inference result provided by an artificial intelligence (AI) system. More particularly, implementations of the present disclosure are directed to selectively displaying an override element in a user interface (UI) based on a confidence score provided by a machine learning (ML) model and a confidence score provided by an adapted ML model. As described herein, implementations of the present disclosure use uncertainty quantification and external additional data to provide a safety mechanism in selectively enabling users to override AI-based decisions. This is particularly relevant in scenarios with critical tasks that are to be executed considering the AI-based decision.

In some implementations, actions include receiving a first input case, outputting a first inference result by processing the first input case through a ML model, and determining that a first confidence score associated with the first inference result fails to meet a first threshold, and in response: providing an adapted ML model based on a set of additional cases, outputting a second inference result by processing a current case through the adapted ML model, the current case including the first input case, and selectively transmitting instructions to display an override element with the first inference result in a user interface. Other implementations of this aspect include corresponding systems, apparatus, and computer programs, configured to perform the actions of the methods, encoded on computer storage devices.

These and other implementations can each optionally include one or more of the following features: selectively transmitting instructions to display an override element with the first inference result in a user interface includes determining that the second inference result is equivalent to the first inference result and that a second confidence score associated with the second inference result is less than the first confidence score, and in response, transmitting instructions to display the override element with the first inference result in the user interface; selectively transmitting instructions to display an override element with the first inference result in a user interface includes determining that the second inference result is not equivalent to the first inference result and that a second confidence score associated with the second inference result meets a second threshold, and in response, transmitting instructions to display the override element with the first inference result in the user interface; the adapted ML model is generated by executing one of continual learning and transfer learning using the set of additional cases; actions further include receiving a second input case, outputting a third inference result by processing the second input case through the ML model, and determining that a third confidence score associated with the second inference result at least meets the first threshold, and in response transmitting instructions to display the third inference result absent the override element; actions further include receiving user input indicating instructions to override the first inference result, and in response, replacing the first inference result with the second inference result in execution of a task, and adding the first input case and the second inference result as an additional case in the set of additional cases; additional case in the set of additional cases represents a respective instance of overriding an inference result; the current case further includes the first inference result; the current case further includes an inference result that is opposite to the first inference result; and the first confidence score is determined by estimating uncertainty using one or more of a gradient episodic technique and a deep ensemble technique.

It is appreciated that methods in accordance with the present disclosure can include any combination of the aspects and features described herein. That is, for example, apparatus and methods in accordance with the present disclosure are not limited to the combinations of aspects and features specifically described herein, but also may include any combination of the aspects and features provided.

The details of one or more implementations of the present disclosure are set forth in the accompanying drawings and the description below. Other features and advantages of the present disclosure will be apparent from the description, drawings, and claims.

### BRIEF DESCRIPTION OF DRAWINGS

FIG. 1 depicts an example system that can execute implementations of the present disclosure.

FIG. 2 depicts a conceptual architecture in accordance with implementations of the present disclosure.

FIG. 3 depicts an example use case in accordance with implementations of the present disclosure.

FIG. 4 depicts an example process in accordance with implementations of the present disclosure.

Like reference numbers and designations in the various drawings indicate like elements.

### DETAILED DESCRIPTION

Implementations of the present disclosure are generally directed to selectively enabling override of an inference result provided by an artificial intelligence (AI) system. More particularly, implementations of the present disclosure are directed to selectively displaying an override element in a user interface (UI) based on a confidence score provided by a machine learning (ML) model and a confidence score provided by an adapted ML model. As described herein, implementations of the present disclosure use uncertainty quantification and external additional data to provide a safety mechanism in selectively enabling users to override AI-based decisions. This is particularly relevant in scenarios with critical tasks that are to be executed considering the AI-based decision.

In some implementations, actions include receiving a first input case, outputting a first inference result by processing the first input case through a ML model, and determining that a first confidence score associated with the first inference result fails to meet a first threshold, and in response: providing an adapted ML model based on a set of additional cases, outputting a second inference result by processing a current case through the adapted ML model, the current case including the first input case, and selectively transmitting instructions to display an override element with the first inference result in a user interface.

Implementations of the present disclosure are described in further detail herein with reference to an example use case. The example use case includes using a ML model to determine whether to prescribe an injection (e.g., of a medicine) to a patient. It is contemplated, however, that implementations of the present disclosure can be realized with any appropriate use case, in which one or more ML models provide decisions (e.g., approving/denying a loan).

To provide further context, and as introduced above, technologies related to AI and ML, AI and ML being used interchangeably herein, have been widely applied in various fields. For example, AI-based decision systems can be used to make decisions on subsequent tasks. In one example context, an AI-based decision system can be used to make a decision on a treatment course of a patient (e.g., prescribe/not prescribe a drug). In another example context, an AI-based decision system can be used to make a decision on whether to approve a customer for a loan. In general, an output of an AI-based decision system can be referred to as a prediction or an inference result.

However, the ML models that underly AI-based decision systems are black-box to users. For example, data is input to a ML model, and the ML model provides output based on the data. The ML model, however, does not provide an indication as to what resulted in the output (i.e., why the ML model provided the particular inference result). In view of this, so-called explainable AI (XAI) has been developed to make the black-box of AI more transparent and understandable. In general, XAI refers to methods and techniques in the application of AI to enable results being more understandable to users and can include providing reasoning for inference results and presenting inference results in an understandable way.

Even with XAI, when it comes to critical issues (e.g., medical diagnosis, investment decisions), and in some scenarios, users might not want to adopt predictions made by ML models. For example, a user may recognize that an inference result is non-optimal, or even incorrect for a given scenario. Here, the user may want to be able to opt-out of accepting the inference result and/or override the inference result with a user-determined result. However, traditional AI-based decision systems are absent technologies to enable such user action in a safe manner.

In view of the foregoing, and as introduced above, implementations of the present disclosure include an override system that selectively enables overriding of an inference result provided by an AI system. More particularly, and as described in further detail herein, implementations of the present disclosure are directed to selectively displaying an override element in a UI based on a first confidence score provided by a ML model and a second confidence score provided by an adapted ML model. In some examples, in response to the first confidence score of a first inference result (also referred to as first result) of an ML model failing to meet (e.g., be equal to or greater than) a threshold, the ML model is adapted to provide an adapted ML model. The adapted ML model provides a second inference result (also referred to as second result) and a second confidence score. In response to the second result and the second confidence score of the adapted ML model, an override element is selectively displayed to enable a user to override the ML model, if desired.

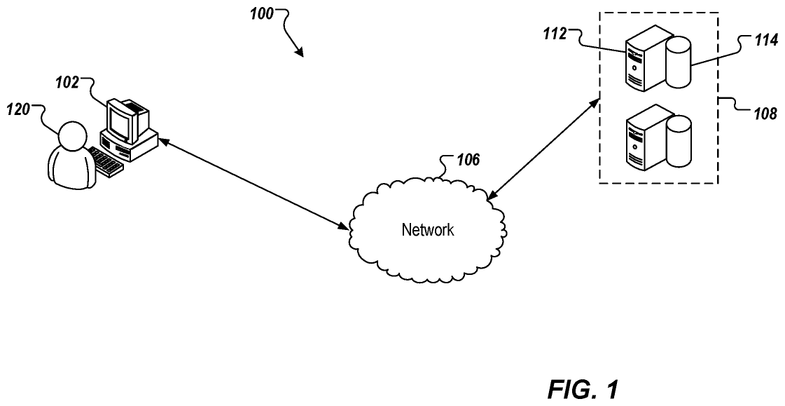

FIG. 1 depicts an example system 100 that can execute implementations of the present disclosure. The example system 100 includes a computing device 102, a back-end system 108, and a network 106. In some examples, the network 106 includes a local area network (LAN), wide area network (WAN), the Internet, or a combination thereof, and connects web sites, devices (e.g., the computing device 102), and back-end systems (e.g., the back-end system 108). In some examples, the network 106 can be accessed over a wired and/or a wireless communications link.

In some examples, the computing device 102 can include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices.

In the depicted example, the back-end system 108 includes at least one server system 112, and data store 114 (e.g., database and knowledge graph structure). In some examples, the at least one server system 112 hosts one or more computer-implemented services that users can interact with using computing devices. For example, the server system 112 can host one or more applications that are provided as part of an override system in accordance with implementations of the present disclosure.

In some examples, the back-end system 108 hosts an AI-based decision system that includes one or more ML models for decision-making. In some examples, an ML model receives input data and generates an inference result based on the input data. In some examples, the inference result represents a decision that can be used for a downstream task. For example, and in the example context, the inference result can represent a decision to prescribe, or not prescribe an injection to a patient. The back-end system 108 can also host an override system in accordance with implementations of the present disclosure. In some examples, the override system is integrated in and is part of the AI-based decision system (e.g., is a sub-system of the AI-based decision system). In some examples, the override system is separate from, but interacts with the AI-based decision system. As described in further detail herein, the override system selectively enables overriding of inference results provided from the AI-based decision system.

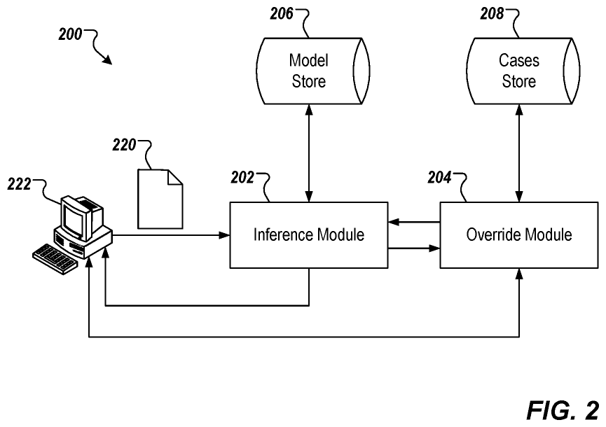

FIG. 2 depicts a conceptual architecture 200 in accordance with implementations of the present disclosure. In the example of FIG. 2, the conceptual architecture 200 includes an inference module 202, an override module 204, a ML model store 206, and a cases store 208. As described in further detail herein, the inference module 202 receives input data 220 from a computing device 222 (e.g., the computing device 102 of FIG. 1). In some examples, the input data 220 is provided as a computer-readable file that records data representative of a case, for which a decision is to be made. In the example use case, a case can include data representative of a patient, for which it is to be determined whether an injection is to be prescribed.

In some examples, the inference module 202 executes inferencing using a ML model and the input data 220. For example, the inference module 202 can load a ML model that is stored within the ML model store 206 for execution. For example, one or more ML models can be trained based on training data and can be stored in the ML model store 206. In general, during a training phase, a ML model is iteratively trained, where, during an iteration, one or more parameters of the ML model are adjusted, and an output is generated based on the training data (i.e., the prepared data). For each iteration, a loss value is determined based on a loss function (e.g., RMSE). The loss value represents a degree of accuracy of the output of the ML model. The loss value can be described as a representation of a degree of difference between the output of the ML model and an expected output of the ML model (the expected output being provided from training data). In some examples, if the loss value does not meet an expected value (e.g., is not equal to zero), parameters of the ML model are adjusted in another iteration of training. In some instances, this process is repeated until the loss value meets the expected value.

In some examples, during an inference phase, the ML model receives the input data 220 and provides output data that includes an inference result determined by the ML model, and a confidence score associated with the inference result. In some examples, the inference result and associated confidence score output by the ML model can be referred to as a first inference result and a first confidence score. In some examples, the confidence score represents a level of confidence that the ML model has in the inference result provided for the particular input data 220. In some examples, different inference results can be associated with different confidence scores based on a variety of factors. Example factors can include, without limitation, a sparsity of the input data 220, and how similar the input data 220 is to training data that had been used to train the ML model. For example, the fewer data points included in the input data 220, the less information the ML model has to determine the inference result. As another example, the more dissimilar the input data 220 is to the training data used to train the ML model, the less likely the ML model is to confidently discern a decision based on the input data 220.

A confidence score for an inference result can be determined using various techniques. An example technique includes, without limitation, quantifying confidence (which can also be referred to as uncertainty) using a deep ensemble. In general, the deep ensemble technique includes training a set of ML models (referred to as an ensemble) using the same training data, but with random initialization of each of the ML models in the set of ML models. Inference results of the ML models in the set of ML models can be aggregated to obtain an uncertainty estimation, represented as a confidence score. Deep ensembles are described in detail in “Simple and Scalable Predictive Uncertainty Estimation using Deep Ensembles” by Lakshminarayanan et al. (Nov. 4, 2017), which is expressly incorporated herein by reference for all purposes.

In accordance with implementations of the present disclosure, the inference model 202 determines whether the confidence score of the inference result meets (e.g., is equal to or greater than) a (first) threshold confidence score (e.g., 50%). In other words, it is determined whether there is a threshold level of certainty in the inference result. In some examples, if the confidence score of the inference result meets the threshold confidence score, the inference result is returned absent ability to override. For example, the inference result is returned for display to the user without an override element. As another example, a subsequent task is automatically performed based on the inference result (e.g., a status of a loan application is changed to approved (or denied) based on the inference result).

In some implementations, if the confidence score of the inference result does not meet the threshold confidence score, the override module 204 determines whether the user should be afforded an opportunity to override the inference result. In some implementations, the inference module 202 provides the ML model and the input data 220 to the override module 204. The override module 204 retrieves a set of additional cases from the cases store 208. In some examples, each case in the set of additional cases is representative of a case that the ML model was not trained on. For example, a case in the set of additional cases can be representative of an instance, in which a user overrode an inference result of the ML model. As another example, a case in the set of additional cases can be representative of an instance, in which a user was offered the option to override an inference result of the ML model, but chose not to override the inference result.

In accordance with implementations of the present disclosure, the override module 204 adapts the ML model based on the set of additional cases to provide an adapted ML model. In some examples, the override module 204 adapts the ML model based on the input data 220, as part of a current case, and the set of additional cases to provide the adapted ML model. In some examples, the current case can include the input data and the inference result (i.e., the inference result provided by the ML model based on the input data). In some examples, the current case can include the input data and a different inference result (i.e., an inference result that is opposite to the inference result provided by the ML model based on the input data). Example techniques for adapting the ML model include, without limitation, transfer learning and incremental learning.

In general, transfer learning considers each additional case in the set of additional cases as a new use case that the ML model is to adapt to. More particularly, in transfer learning, knowledge of a (trained) ML model is applied to a different, but related problem. Transfer learning is described in detail in “A survey of transfer learning,” Weiss et al., Journal of Big Data, 3(1):9 (December 2016), which is expressly incorporated herein by reference in the entirety for all purposes.

In general, incremental learning, which is also referred to as continual learning, adapts the ML model to account for additional cases without having to re-train the ML model. More particularly, incremental learning includes using the additional cases to extend the knowledge of the ML model, the extension of knowledge being represented in the adapted ML model. In some examples, incremental learning is performed using gradient episodic memory with deep ensemble to train the adapted ML model. In some examples, a portion of the training data that had been used to train the ML model is interleaved with data representative of the additional cases to train the adapted ML model in a sequence of tasks. In deep ensemble, several sequences of tasks are trained in parallel to collectively measure uncertainty. Incremental learning using gradient episodic memory is described in detail in “Gradient Episodic Memory for Continual Learning” by Lopez-Paz et al. (Nov. 4, 2017), which is expressly incorporated herein by reference in the entirety for all purposes.

In accordance with implementations of the present disclosure, the adapted ML model receives the input data 220 and provides output data that includes an inference result determined by the adapted ML model, and a confidence score associated with the inference result. In some examples, the inference result and associated confidence score output by the adapted ML model can be referred to as a second inference result and a second confidence score.

In some implementations, in response to the second result and the second confidence score of the adapted ML model, an override element is selectively displayed to enable a user to override the ML model, if desired. In some examples, the override module 204 determines whether the first inference result (i.e., that provided by the ML model) is the same as, or sufficiently similar to, the second inference result (i.e., that provided by the adapted ML model). In some examples, if the first inference result is the same as, or sufficiently similar to, the second inference result, the override module 204 determines whether the second confidence score is less than the first confidence score. That is, the override module 204 determines whether, in view of the set of additional cases (and the current case), there is even less confidence in the first inference result (the second inference result being the same, or sufficiently similar to the first inference result). If the second confidence score is not less than the first confidence score, the override module 204 determines not to enable the first inference result to be overridden. Consequently, the first inference result is provided absent an ability to override. For example, the first inference result is returned for display to the user without an override element. As another example, a subsequent task is automatically performed based on the first inference result (e.g., a status of a loan application is changed to approved (or denied) based on the inference result). If the second confidence score is less than the first confidence score, the override module 204 determines to enable the first inference result to be overridden. Consequently, the first inference result is provided with an interface element that can be selected (e.g., clicked on) to override the first inference result.

In some examples, if the first inference result is the same as, or sufficiently similar to, the second inference result, the override module 204 determines whether the second confidence score meets (e.g., is equal to or greater than) a (second) threshold confidence score (e.g., 60%). In other words, it is determined whether there is a threshold level of uncertainty in the inference result of the adapted ML model. In some examples, if the second confidence score of the second inference result does not meet the second threshold confidence score, the inference result is returned absent ability to override. For example, the inference result is returned for display to the user without an override element. As another example, a subsequent task is automatically performed based on the inference result (e.g., a status of a loan application is changed to approved (or denied) based on the inference result). In some examples, if the second confidence score of the second inference result meets the second threshold confidence score, the override module 204 determines to enable the first inference result to be overridden. Consequently, the first inference result is provided with an interface element that can be selected (e.g., clicked on) to override the first inference result.

In some examples, user input to the interface element is received (e.g., the user clicks on the interface element). The user input can indicate whether to override the first inference result. If the user determines not to override the first inference result, the first inference result is used in a subsequent task (e.g., denying a prescription for an injection). If the user determines to override the first inference result, the second inference result is used in a subsequent task (e.g., issuing a prescription for an injection), and the current case is added to the set of additional cases. That is, for example, the input data and the second inference result are stored as an additional case in the cases store 208.

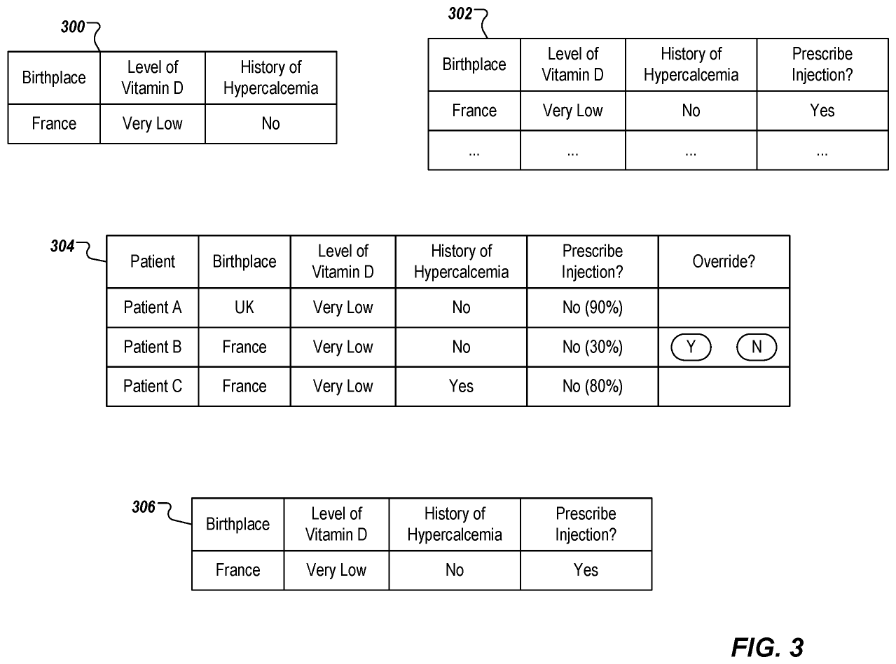

FIG. 3 depicts an example use case in accordance with implementations of the present disclosure. The examples of FIG. 3 correspond to the example context of AI-based determination of whether an injection is to be prescribed. In the example of FIG. 3, input data 300 is provided that represents a current case, for which a decision on prescription is to be made. For example, the input data 300 corresponds to the input data 220 of FIG. 2. In the example of FIG. 3, a set of additional cases 302 is depicted. For example, the set of additional cases 302 corresponds to additional cases stored in the cases store 208 of FIG. 2. In some examples, the set of additional cases 302 includes cases that were not used in training of a ML model that is to process the input data 300 to make a decision.

In the example of FIG. 3, an output result 304 is depicted, which represents AI-based decisions on injection for multiple patients. For example, the output result 304 can be displayed to a user. In the output result 304, an interface element is provided for Patient B, the interface element enabling the user to override the AI-based decision of not prescribing an injection. In the depicted example, the interface element includes a yes (Y) option that, if selected, overrides the AI-based decision, and a no (N) option that, if selected, accepts the AI-based decision. The example of FIG. 3 also depicts a current case 306. In some examples, the current case 306 is a result of the user overriding the AI-based decision (e.g., the user indicating that an injection is to be prescribed for Patient B, contrary to the AI-based decision).

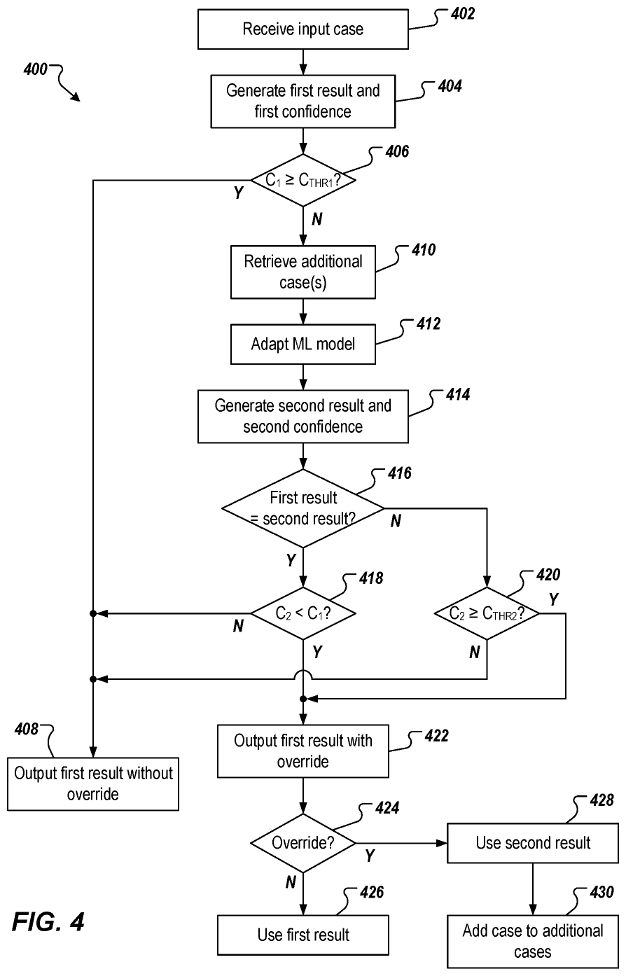

FIG. 4 depicts an example process 400 that can be executed in implementations of the present disclosure. In some examples, the example process 400 is provided using one or more computer-executable programs executed by one or more computing devices.

An input case is received (402). For example, and as described herein, the inference module 202 receives input data 220 from a computing device 222 (e.g., the computing device 102 of FIG. 1). A first inference result (first result) and a first confidence is generated (404). For example, and as described herein, the ML model receives the input data 220 and provides output data that includes a first inference result determined by the ML model, and a first confidence score (CO associated with the first inference result. It is determined whether the first confidence is equal to or greater than a first confidence threshold (406). For example, and as described herein, the inference model 202 determines whether the confidence score of the inference result meets (e.g., is equal to or greater than) a (first) threshold confidence score (C_{THR1}).

If the first confidence is equal to or greater than the first confidence threshold, the first inference result is output without override (408). For example, and as described herein, the inference result is returned for display to the user without an override element. As another example, a subsequent task is automatically performed based on the inference result (e.g., a status of a loan application is changed to approved (or denied) based on the inference result). If the first confidence is not equal to or greater than the first confidence threshold, a set of additional cases is retrieved (410). For example, and as described herein, the inference module 202 provides the ML model and the input data 220 to the override module 204. The override module 204 retrieves a set of additional cases from the cases store 208.

The ML model is adapted (412). For example, and as described herein, the override module 204 adapts the ML model based on the set of additional cases to provide an adapted ML model. In some examples, the override module 204 adapts the ML model based on the input data 220, as part of a current case, and the set of additional cases to provide the adapted ML model. In some examples, the current case can include the input data and the inference result (i.e., the inference result provided by the ML model based on the input data). In some examples, the current case can include the input data and a different inference result (i.e., an inference result that is opposite to the inference result provided by the ML model based on the input data). Example techniques for adapting the ML model include, without limitation, transfer learning and incremental learning.

A second inference result (second result) and a second confidence is generated (414). For example, and as described herein, the adapted ML model receives the input data 220 and provides output data that includes a second inference result determined by the adapted ML model, and a second confidence score (C₂) associated with the inference result. It is determined whether the first result is equal to the second result (416). If the first result is equal to the second result, it is determined whether the second confidence is less than the first confidence (418). If the second confidence is not less than the first confidence, the first inference result is output without override (408). For example, and as described herein, the first inference result is returned for display to the user without an override element. As another example, a subsequent task is automatically performed based on the first inference result (e.g., a status of a loan application is changed to approved (or denied) based on the inference result). If the second confidence is less than the first confidence, the first inference result is output with override (422). For example, and as described herein, the first inference result is provided with an interface element that can be selected (e.g., clicked on) to override the first inference result.

If the first result is not equal to the second result, it is determined whether the second confidence is greater than or equal to a second confidence threshold (420). For example, and as described herein, the override module 204 determines whether the second confidence score meets (e.g., is equal to or greater than) a (second) threshold confidence score (e.g., 60%). If the second confidence is not greater than or equal to the second confidence threshold, the first inference result is output without override (408). If the second confidence is greater than or equal to the second confidence threshold, the first inference result is output with override (422).

It is determined whether the first inference result is to be overridden (424). For example, and as described herein, user input to the interface element is received (e.g., the user clicks on the interface element). The user input can indicate whether to override the first inference result. If the first inference result is to be overridden, the first inference result is used (426). If the first inference result is to be overridden, the second inference result is used (428). The case is added to the additional cases (430). For example, and as described herein, the current case is added to the set of additional cases. That is, for example, the input data and the second inference result are stored as an additional case in the cases store 208.

As described herein, implementations of the present disclosure use uncertainty quantification and external additional data to provide a safety mechanism in selectively enabling users to override AI-based decisions. That is, the additional cases are provided to do a dry-run of the override (i.e., the second inference result) to determine whether it would be safe to allow the user to override. Safety can be in terms of avoiding physical harm and/or economic harm, for example. This is particularly relevant in scenarios with critical tasks that are to be executed considering the AI-based decision.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method for selectively enabling override of an inference result provided by an artificial intelligence (AI) system, the method comprising:
receiving a first input case;
outputting a first inference result by processing the first input case through a machine learning (ML) model; and
determining that a first confidence score associated with the first inference result fails to meet a first threshold, and in response:
providing an adapted ML model based on a set of additional cases,
outputting a second inference result by processing a current case through the adapted ML model, the current case comprising the first input case, and
selectively transmitting instructions to display an override element with the first inference result in a user interface.

2. The method of claim 1, wherein selectively transmitting instructions to display an override element with the first inference result in a user interface comprises:
determining that the second inference result is equivalent to the first inference result and that a second confidence score associated with the second inference result is less than the first confidence score, and in response, transmitting instructions to display the override element with the first inference result in the user interface.

3. The method of claim 1, wherein selectively transmitting instructions to display an override element with the first inference result in a user interface comprises:
determining that the second inference result is not equivalent to the first inference result and that a second confidence score associated with the second inference result meets a second threshold, and in response, transmitting instructions to display the override element with the first inference result in the user interface.

4. The method of claim 1, wherein the adapted ML model is generated by executing one of continual learning and transfer learning using the set of additional cases.

5. The method of claim 1, further comprising:
receiving a second input case;
outputting a third inference result by processing the second input case through the ML model; and
determining that a third confidence score associated with the second inference result at least meets the first threshold, and in response:
transmitting instructions to display the third inference result absent the override element.

6. The method of claim 1, further comprising receiving user input indicating instructions to override the first inference result, and in response:
replacing the first inference result with the second inference result in execution of a task; and
adding the first input case and the second inference result as an additional case in the set of additional cases.

7. The method of claim 1, wherein each additional case in the set of additional cases represents a respective instance of overriding an inference result.

8. The method of claim 1, wherein the current case further comprises the first inference result.

9. The method of claim 1, wherein the current case further comprises an inference result that is opposite to the first inference result.

10. The method of claim 1, wherein the first confidence score is determined by estimating uncertainty using one or more of a gradient episodic technique and a deep ensemble technique.

11. A system, comprising:
one or more processors; and
a computer-readable storage device coupled to the one or more processors and having instructions stored thereon which, when executed by the one or more processors, cause the one or more processors to perform operations for selectively enabling override of an inference result provided by an artificial intelligence (AI) system, the operations comprising:
receiving a first input case;
outputting a first inference result by processing the first input case through a machine learning (ML) model; and
determining that a first confidence score associated with the first inference result fails to meet a first threshold, and in response:
providing an adapted ML model based on a set of additional cases,
outputting a second inference result by processing a current case through the adapted ML model, the current case comprising the first input case, and
selectively transmitting instructions to display an override element with the first inference result in a user interface.

12. The system of claim 11, wherein selectively transmitting instructions to display an override element with the first inference result in a user interface comprises:
determining that the second inference result is equivalent to the first inference result and that a second confidence score associated with the second inference result is less than the first confidence score, and in response, transmitting instructions to display the override element with the first inference result in the user interface.

13. The system of claim 11, wherein selectively transmitting instructions to display an override element with the first inference result in a user interface comprises:
determining that the second inference result is not equivalent to the first inference result and that a second confidence score associated with the second inference result meets a second threshold, and in response, transmitting instructions to display the override element with the first inference result in the user interface.

14. The system of claim 11, wherein the adapted ML model is generated by executing one of continual learning and transfer learning using the set of additional cases.

15. The system of claim 11, wherein operations further comprise:
receiving a second input case;
outputting a third inference result by processing the second input case through the ML model; and
determining that a third confidence score associated with the second inference result at least meets the first threshold, and in response:
transmitting instructions to display the third inference result absent the override element.

16. The system of claim 11, wherein operations further comprise receiving user input indicating instructions to override the first inference result, and in response:
replacing the first inference result with the second inference result in execution of a task; and
adding the first input case and the second inference result as an additional case in the set of additional cases.

17. The system of claim 11, wherein each additional case in the set of additional cases represents a respective instance of overriding an inference result.

18. The system of claim 11, wherein the current case further comprises the first inference result.

19. The system of claim 11, wherein the current case further comprises an inference result that is opposite to the first inference result.

20. The system of claim 11, wherein the first confidence score is determined by estimating uncertainty using one or more of a gradient episodic technique and a deep ensemble technique.

21. Computer-readable storage media coupled to the one or more processors and having instructions stored thereon which, when executed by the one or more processors, cause the one or more processors to perform operations for selectively enabling override of an inference result provided by an artificial intelligence (AI) system, the operations comprising:
receiving a first input case;
outputting a first inference result by processing the first input case through a machine learning (ML) model; and
determining that a first confidence score associated with the first inference result fails to meet a first threshold, and in response:
providing an adapted ML model based on a set of additional cases,
outputting a second inference result by processing a current case through the adapted ML model, the current case comprising the first input case, and
selectively transmitting instructions to display an override element with the first inference result in a user interface.

22. The computer-readable storage media of claim 21, wherein selectively transmitting instructions to display an override element with the first inference result in a user interface comprises:
determining that the second inference result is equivalent to the first inference result and that a second confidence score associated with the second inference result is less than the first confidence score, and in response, transmitting instructions to display the override element with the first inference result in the user interface.

23. The computer-readable storage media of claim 21, wherein selectively transmitting instructions to display an override element with the first inference result in a user interface comprises:
determining that the second inference result is not equivalent to the first inference result and that a second confidence score associated with the second inference result meets a second threshold, and in response, transmitting instructions to display the override element with the first inference result in the user interface.

24. The computer-readable storage media of claim 21, wherein the adapted ML model is generated by executing one of continual learning and transfer learning using the set of additional cases.

25. The computer-readable storage media of claim 21, wherein operations further comprise:
receiving a second input case;
outputting a third inference result by processing the second input case through the ML model; and
determining that a third confidence score associated with the second inference result at least meets the first threshold, and in response:
transmitting instructions to display the third inference result absent the override element.

26. The computer-readable storage media of claim 21, wherein operations further comprise receiving user input indicating instructions to override the first inference result, and in response:
replacing the first inference result with the second inference result in execution of a task; and
adding the first input case and the second inference result as an additional case in the set of additional cases.

27. The computer-readable storage media of claim 21, wherein each additional case in the set of additional cases represents a respective instance of overriding an inference result.

28. The computer-readable storage media of claim 21, wherein the current case further comprises the first inference result.

29. The computer-readable storage media of claim 21, wherein the current case further comprises an inference result that is opposite to the first inference result.

30. The computer-readable storage media of claim 21, wherein the first confidence score is determined by estimating uncertainty using one or more of a gradient episodic technique and a deep ensemble technique.
